(19) United States
(12) Patent Application Publication
(10) Pub. No.: US 2025/0299453 A1
(43) Pub. Date: Sep. 25, 2025

(54) META-SPACE GENERATION METHOD BASED ON USER SPACE ALIGNMENT IN METAVERSE AND APPARATUS FOR THE SAME

(71) Applicant: ELECTRONICS AND TELECOMMUNICATIONS RESEARCH INSTITUTE, Daejeon (KR)

(72) Inventor: Hye-Sun PARK, Daejeon (KR)

(21) Appl. No.: 19/084,327

(22) Filed: Mar. 19, 2025

(30) Foreign Application Priority Data
Mar. 20, 2024 (KR) 10-2024-0038295

(51) Int. Cl. G06T 19/20

(52) U.S. Cl. CPC G06T 19/20; G06T 2219/024; G06T 2219/2004; G06T 2219/2016

(57) ABSTRACT

Disclosed herein are a meta-space generation method based on user space alignment in metaverse and an apparatus for the same. The meta-space generation method is performed by a meta-space generation apparatus and includes generating a user space having a three-dimensional (3D) virtual space form based on a user space image captured through a user terminal, analyzing a structural feature of the user space in consideration of a background and objects that constitute the user space, searching for a mutually shareable space that satisfies alignment conditions in which the structural feature is taken into consideration based on user space data of other users registered in a user space database, and generating a meta-space that is mutually shareable with other users in metaverse by aligning the user space to the mutually shareable space.

### CROSS REFERENCE TO RELATED APPLICATION

This application claims the benefit of Korean Patent Application No. 10-2024-0038295, filed Mar. 20, 2024, which is hereby incorporated by reference in its entirety into this application.

### BACKGROUND OF THE INVENTION

### 1. Technical Field

The present disclosure relates generally to meta-space generation technology based on user space alignment in metaverse, and more particularly to meta-space generation technology for automatically generating a three-dimensional (3D) virtual space by utilizing vast 2D images, which are acquired easily by the general public and which include variations in time zones and viewpoints, as big data, and for allowing multiple users to map, share, interact with, and edit the 3D virtual space in conformity with respective user spaces.

### 2. Description of the Related Art

Generally, the general public can conveniently use the Internet and smartphones have been popularized, a communication culture through Social Networking Services (SNS) has developed. This means that various multiple images may be obtained in real time, and most obtained images are 2D images and occasionally include images including three-dimensional (3D) information.

Among vision technologies that are recent trending issues, a ‘technique for generating 3D models from 2D images captured from various viewpoints (directions or orientation) of a single object’ is being actively developed in conjunction with deep learning technology. Technology such as Neural Radiance Fields for View Synthesis (NeNF) is one example thereof. In the past, technology for extracting or predicting a 3D model from 2D images was continuously developed. However, recently, the technology has evolved into a technique for receiving multiple images captured from an object and generating object images from new viewpoints. Further, this technology continuously synthesizes the appearances of a target viewed from unspecified positions and directions based on images captured from specific several viewpoints. That is, in the future, pieces of big data of the same object acquired from various viewpoints (i.e., times, orientation, positions, etc.) are integrated and connected to generate massive 3D data. Such 3D data may be merged and utilized through various synthesis techniques and application fields.

When 3D data about various real-world objects become one piece of data that can be easily used by general users, the general users may personally and easily synthesize, modify, edit and share 3D data.

With the development of these technologies and evolving times, general users will encounter a metaverse environment in which various types of virtual and real-world information are integrated and in which various activities are possible. Here, in the metaverse environment, various/multiple users may coexist, and may share various types of information as needed. Therefore, there are required methodology and technology that allow the users to use the corresponding information in conformity with respective environments and states of the users and to conveniently interact with other users.

### PRIOR ART DOCUMENTS

### Patent Documents

(Patent Document 1) Korean Patent Application Publication No. 10-2002-0039882 (Date of Publication: May 30, 2002, Title: Client Apparatus and Operating Method of Distributed Shared Virtual Space System)

### SUMMARY OF THE INVENTION

Accordingly, the present disclosure has been made keeping in mind the above problems occurring in the prior art, and an object of the present disclosure is to provide technology configured such that, when various types of information acquired in real-time by various multiple users are fused, the users may be provided with information suitable for environments and conditions of the users and may further generate a meta-space in which free interaction and editing are possible.

Another object of the present disclosure is to configure objects in a meta-space that can be shared among multiple users while the users interact with each other based on big data acquired from the multiple users.

A further object of the present disclosure is to provide technology that allows real objects in a physical space to be edited and modified in accordance with individual users' needs through a mutually shared meta-space, without requiring physical space movement (i.e., physical relocation).

In accordance with an aspect of the present disclosure to accomplish the above objects, there is provided a meta-space generation method performed by a meta-space generation apparatus, the meta-space generation method including generating a user space having a three-dimensional (3D) virtual space form based on a user space image captured through a user terminal; analyzing a structural feature of the user space in consideration of a background and objects that constitute the user space; searching for a mutually shareable space that satisfies alignment conditions in which the structural feature is taken into consideration based on user space data of other users registered in a user space database; and generating a meta-space that is mutually shareable with other users in metaverse by aligning the user space to the mutually shareable space.

The alignment conditions may include a condition ensuring that similarity to the background of the user space is equal to or higher than a reference level and a condition ensuring that an activity-allowed space, extracted in consideration of the structural feature, does not overlap between the user space and the mutually shareable space.

The meta-space may be generated to include all of objects constituting the user space and objects constituting the mutually shareable space.

Generating the meta-space may include performing alignment on a position, orientation, and a scale between the user space and the mutually shareable space.

The mutually shareable space may be a user space for each of the other users generated through user terminals thereof.

The meta-space may be capable of being edited by multiple users who share the meta-space, and edited information may be shared with the multiple users who share the meta-space.

When a change occurs in an activity-allowed space in the user space or in an activity-allowed space in the mutually shareable space due to editing, the meta-space may be updated to correspond to a changed activity-allowed space.

Generating the user space may include obtaining object information about real objects included in the user space image based on a big data-based object database, and mapping the objects to the user space in accordance with the object information.

Generating the meta-space may include, when two or more mutually shareable spaces are present, generating the meta-space by aligning the two or more mutually shareable spaces to the user space within a range in which the alignment conditions are satisfied.

In accordance with another aspect of the present disclosure to accomplish the above objects, there is provided a meta-space generation apparatus, including a processor configured to generate a user space having a three-dimensional (3D) virtual space form based on a user space image captured through a user terminal, analyze a structural feature of the user space in consideration of a background and objects that constitute the user space, search for a mutually shareable space that satisfies alignment conditions in which the structural feature is taken into consideration based on user space data of other users registered in a user space database, and generate a meta-space that is mutually shareable with other users in metaverse by aligning the user space to the mutually shareable space; and a user space database configured to store the user space data.

The alignment conditions may include a condition ensuring that similarity to the background of the user space is equal to or higher than a reference level and a condition ensuring that an activity-allowed space, extracted in consideration of the structural feature, does not overlap between the user space and the mutually shareable space.

The meta-space may be generated to include all of objects constituting the user space and objects constituting the mutually shareable space.

The processor may be configured to perform alignment on a position, orientation, and a scale between the user space and the mutually shareable space.

The mutually shareable space may be a user space for each of the other users generated through user terminals thereof.

The meta-space may be capable of being edited by multiple users who share the meta-space, and edited information may be shared with the multiple users who share the meta-space.

When a change occurs in an activity-allowed space in the user space or in an activity-allowed space in the mutually shareable space due to editing, the meta-space may be updated to correspond to a changed activity-allowed space.

The processor may be configured to obtain object information about real objects included in the user space image based on a big data-based object database, and map the objects to the user space in accordance with the object information.

The processor may be configured to, when two or more mutually shareable spaces are present, generate the meta-space by aligning the two or more mutually shareable spaces to the user space within a range in which the alignment conditions are satisfied.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a diagram illustrating a meta-space generation system according to an embodiment of the present disclosure;

FIG. 2 is an operation flowchart illustrating a meta-space generation method based on user space alignment in metaverse according to an embodiment of the present disclosure;

FIG. 3 is a diagram illustrating in detail a meta-space generation process according to the present disclosure;

FIGS. 4 and 5 are diagrams illustrating an example of the image acquisition process illustrated in FIG. 3;

FIG. 6 is a diagram illustrating an example of the result of 3D space data generation illustrated in FIGS. 4 and 5;

FIG. 7 is a diagram illustrating an example of a semantic object extraction process according to the present disclosure;

FIG. 8 is a diagram illustrating an example of an object analysis process according to the present disclosure;

FIGS. 9, 10, and 11 are diagrams illustrating an example of the activity-allowed space simplification process illustrated in FIG. 3;

FIG. 12 is a diagram illustrating an example of the meta-space generation process illustrated in FIG. 3;

FIGS. 13, 14, and 15 are diagrams illustrating another example of a meta-space generation process according to the present disclosure;

FIG. 16 is a diagram illustrating a meta-space generation apparatus according to an embodiment of the present disclosure; and

FIGS. 17, 18, and 19 are diagrams illustrating an example of a meta-space update process based on editing according to the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to make the gist of the present disclosure unnecessarily obscure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated to make the description clearer.

In the present specification, each of phrases such as “A or B”, “at least one of A and B”, “at least one of A or B”, “A, B, or C”, “at least one of A, B, and C”, and “at least one of A, B, or C” may include any one of the items enumerated together in the corresponding phrase, among the phrases, or all possible combinations thereof.

In conventional telepresence technology, a fixed shared space (including objects) was present in a virtual space. However, although such a shared space was aligned to be augmented into the physical space of a user, the shared space did not reflect real objects or environmental elements of the user's physical space. Additionally, the 3D objects included in the shared space were not primarily focused on editing, such as modification or transformation.

However, according to the technology development trend in the future, each user will be able to utilize the counterpart's physical space using his or her own physical space within a meta-space in which various activities become possible, and will be able to edit and share his or her own space or the counterpart's space as needed.

Therefore, in the future, user-customized User Interface (UI) technology and editing technology need to be provided within telepresence technology that utilizes the meta-space.

For this operation, various UI technologies which handle 3D models in existing graphics have been developed.

The present disclosure focuses on technologies and methodologies necessary for allowing each user to move, in the future, from a physical space to which the user belongs (e.g., his or her room) to a meta-space mapped to the physical space of another user based on images that are acquired by various multiple general users in accordance with the current trend, and for enabling various activities to be taken in the meta-space. Therefore, there may be required easy editing UI technology that allows general users, other than experts, to modify a telepresence space in accordance with the user himself or herself.

Hereinafter, embodiments of the present disclosure will be described in detail with reference to the attached drawings.

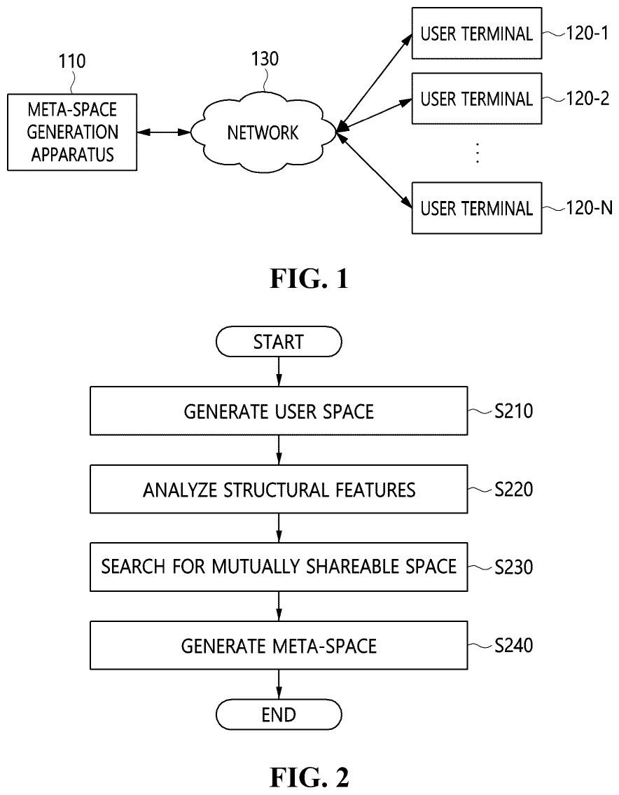

FIG. 1 is a diagram illustrating a meta-space generation system according to an embodiment of the present disclosure.

Referring to FIG. 1, the meta-space generation system according to the embodiment of the present disclosure includes a meta-space generation apparatus 110, user terminals 120-1 to 120-N, and a network 130.

The meta-space generation apparatus 110 generates a user space having a 3D virtual space form based on user space images captured through the user terminals 120-1 to 120-N.

Here, pieces of object information about real objects included in the user space images may be obtained based on a big data-based object database (DB), and the objects may be mapped to the user space in accordance with the pieces of object information.

Also, the meta-space generation apparatus 110 analyzes the structural features of the user space in consideration of background and objects constituting the user space.

Further, the meta-space generation apparatus 110 searches for a mutually shareable space that satisfies alignment conditions in which the structural features are taken into consideration, based on user space data of other users registered in a user space database.

Here, the alignment conditions may include a condition ensuring that the similarity to the background of the user space is equal to or higher than a reference level and a condition ensuring that an activity-allowed space, extracted in consideration of the structural features, does not overlap between the user space and the mutually shareable space.

Here, the mutually shareable space may be the user space of the other user, generated through the other user's terminal.

Further, the meta-space generation apparatus 110 generates a meta-space shareable with other users in the metaverse by aligning the user space to the mutually shareable space.

Here, the meta-space may be generated to include all of objects constituting the user space and objects constituting the mutually shareable space.

Here, alignment may be performed on the position, orientation, and scale between the user space and the mutually shareable space.

Here, the meta-space may be edited by the multiple users who share the meta-space, and the edited information may be shared with the multiple users who share the meta-space.

Here, when a change occurs in the activity-allowed space in the user space or in the activity-allowed space in the mutually shareable space due to editing, the meta-space may be updated to correspond to the changed activity-allowed space.

In this case, when there are two or more mutually shareable spaces, the meta-space may be generated by aligning the two or more mutually shareable spaces to the user space within a range in which the alignment conditions are satisfied.

Each of the user terminals 120-1 to 120-N may be a device that is connected to a communication network to be capable of communicating with the meta-space generation apparatus 110. For example, each of the user terminals 120-1 to 120-N may be any of various terminals such as all types of data communication equipment, multimedia terminals, wired terminals, fixed terminals, mobile communication terminals, and Internet Protocol (IP) terminals. Further, each of the user terminals 120-1 to 120-N may be any of mobile terminals having various mobile communication specifications such as a mobile phone, a Portable Multimedia Player (PMP), a Mobile Internet Device (MID), a smartphone, a desktop computer, a tablet computer (Tablet PC), a notebook, Netbook, a Personal Digital Assistant (PDA), a smart TV, and data communication equipment.

The network 130 provides a path through which data is transferred between the meta-space generation apparatus 110 and the user terminals 120-1 to 120-N, and is a concept embracing both existing networks that have been conventionally used and networks that may be developed in the future. For example, the network 130 may be any one of a wired/wireless Local Area Network (LAN) for providing communication between various types of information devices in a limited area, a mobile communication network for providing communication between individual moving objects and between a moving object and a system outside the moving object, a satellite communication network for providing communication between individual earth stations using satellites, or a wired/wireless communication network, or a combination of two or more thereof. Meanwhile, transmission method standards for the network are not limited to existing transmission method standards, but may include all transmission method standards to be developed in the future.

FIG. 2 is an operation flowchart illustrating a meta-space generation method based on user space alignment in metaverse according to an embodiment of the present disclosure.

Referring to FIG. 2, in the meta-space generation method based on user space alignment in metaverse according to the embodiment of the present disclosure, the meta-space generation apparatus generates a user space having a 3D virtual space form based on a user space image captured by a user terminal at step S210.

Here, pieces of object information about real objects included in the user space image may be obtained based on a big data-based object database (DB), and the objects may be mapped to the user space in accordance with the pieces of object information.

Further, in the meta-space generation method based on user space alignment in metaverse according to the embodiment of the present disclosure, the meta-space generation apparatus analyzes the structural features of the user space in consideration of background and objects constituting the user space at step S220.

Furthermore, in the meta-space generation method based on user space alignment in metaverse according to the embodiment of the present disclosure, the meta-space generation apparatus searches for a mutually shareable space that satisfies alignment conditions in which the structural features are taken into consideration, based on user space data of other users registered in a user space database at step S230.

Here, the alignment conditions may include a condition ensuring that the similarity to the background of the user space is equal to or higher than a reference level and a condition ensuring that an activity-allowed space, extracted in consideration of the structural features, does not overlap between the user space and the mutually shareable space.

Here, the mutually shareable space may be the user space of another user, generated through the other user's terminal.

Furthermore, in the meta-space generation method based on user space alignment in metaverse according to the embodiment of the present disclosure, the meta-space generation apparatus generates a meta-space that is shareable with other users in the metaverse by aligning the user space to the mutually shareable space at step S240.

Here, the meta-space may be generated to include all of objects constituting the user space and objects constituting the mutually shareable space.

Here, alignment may be performed on the position, orientation, and scale between the user space and the mutually shareable space.

Here, the meta-space may be edited by the multiple users who share the meta-space, and the edited information may be shared with the multiple users who share the meta-space.

Here, when a change occurs in the activity-allowed space in the user space or in the activity-allowed space in the mutually shareable space due to editing, the meta-space may be updated to correspond to the changed activity-allowed space.

In this case, when there are two or more mutually shareable spaces, the meta-space may be generated by aligning the two or more mutually shareable spaces to the user space within a range in which the alignment conditions are satisfied.

By utilizing the meta-space generation method, there can be provided technology configured such that, when various types of information acquired in real-time by various multiple users are fused, the users may be provided with information suitable for environments and conditions of the users and may further generate a meta-space in which free interaction and editing are possible.

In addition, objects in the meta-space that can be shared while enabling interactions may be configured based on big data obtained from the multiple users.

In addition, there can be provided technology that allows real objects in a physical space to be edited and modified in accordance with individual users' needs through a mutually shared meta-space, without requiring physical space movement.

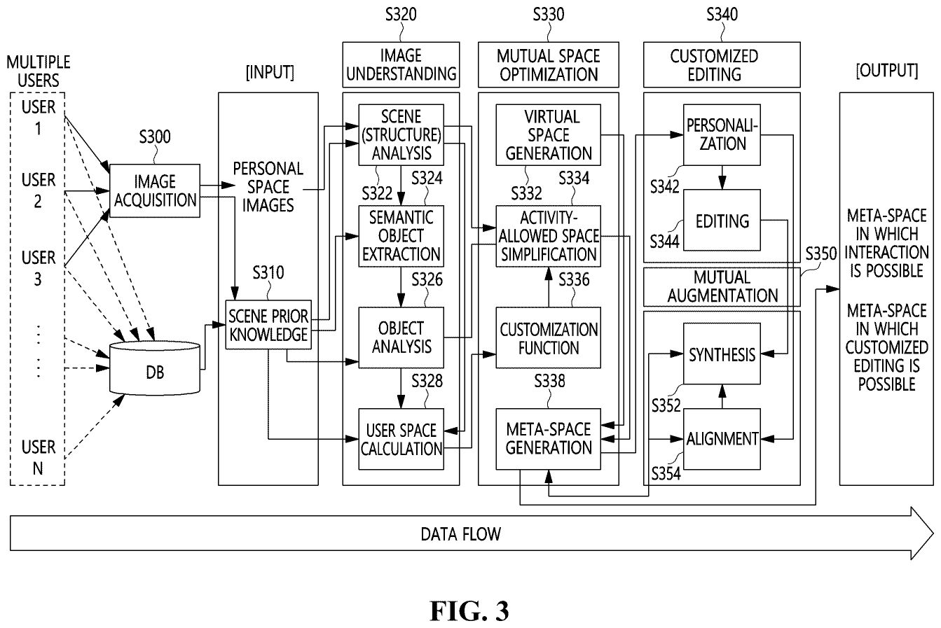

FIG. 3 is a diagram illustrating in detail a meta-space generation process according to the present disclosure.

Recently, multiple users share images, obtained by capturing several spaces and several objects from various viewpoints (times, orientation, positions, etc.) of multiple spaces and objects, through multiple routes. Prior knowledge (information) may be extracted from the various shared images by combining vision with graphics technologies based on deep learning technology with respect to relationships and recognition of various objects filling the space captured in the images, 3D object generation, the recognition of relationships between spatial structures and overall scenes, and 3D space generation. The prior knowledge may then be utilized as a database.

The present disclosure is used based on knowledge information previously obtained through such technology. Hereinafter, a process of generating a meta-space using the knowledge information will be described in detail with reference to FIG. 3.

FIG. 3 is a diagram illustrating in detail a meta-space generation process. Referring to FIG. 3, multiple users who wish to interact through the meta-space may capture part or all of their own spaces desired to be shared, thus acquiring multiple user space images at step S300. In this case, a capturing tool may be a device suiting each user's convenience, and images captured through various capturing tools may be converted into a single unified type to acquire images.

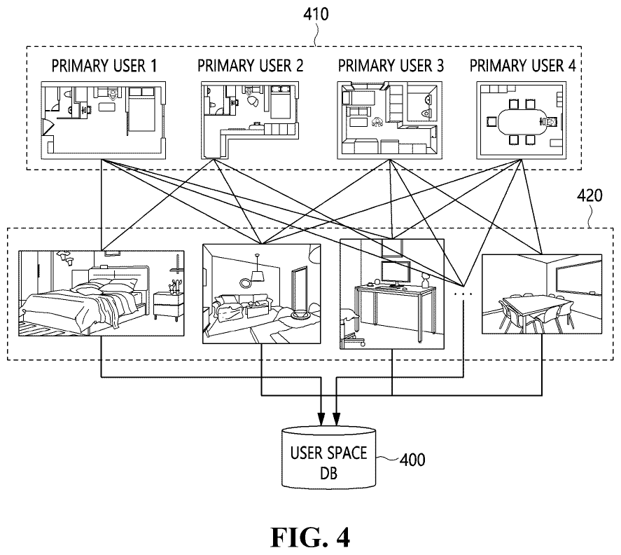

For example, as illustrated in FIG. 4, multiple user space images 420 may be acquired based on videos captured by multiple primary users 410, who wish to perform interaction through meta-spaces, using their own capturing tools, and may then be stored in a user space database (DB) 400.

Here, the user space images may include 3D reconstructed images (e.g., 3D images of the entire room within 360 degrees), user room images at various angles, images of objects (e.g., furniture or the like) placed in the user room, etc.

Thereafter, components constituting a space corresponding to each of the user space images may be understood based on scene prior knowledge (information) trained with big data in advance at step S320.

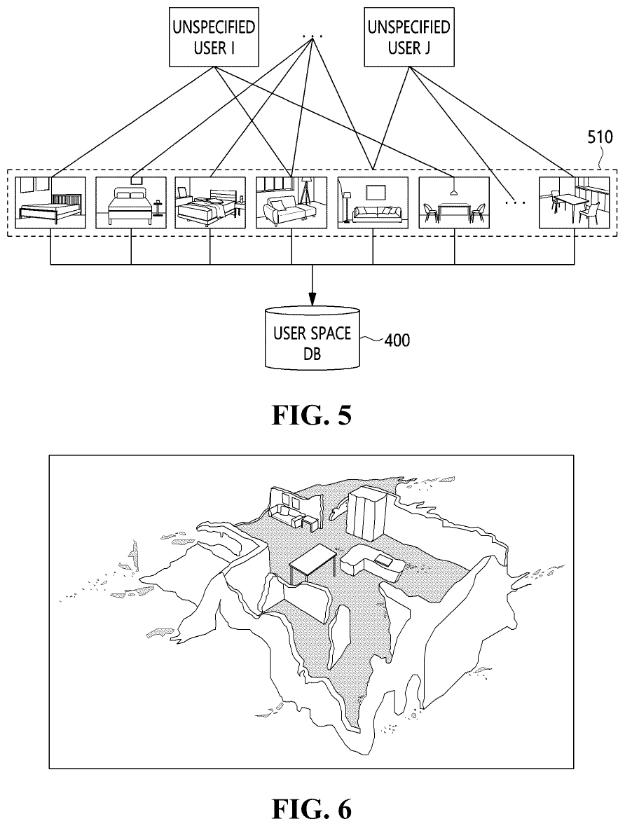

Here, as illustrated in FIG. 5, the scene prior knowledge (information) at step S310 may be generated based on images related to various objects included in user space images 510 acquired from unspecified users.

For example, scene prior knowledge (information) may be generated using a method such as Neural Radiance Fields for View Synthesis (NeRF) or 3D Gaussian Splatting.

When step S320 is described in detail, the structure (e.g., position, orientation, or the like) of the background, objects, etc. is analyzed from received user space images at step S322, and then the objects constituting the user space may be extracted/segmented/classified at step S324. Based on techniques such as scene graphs, the relationships between these objects within the scene may be recognized, and the objects may be analyzed at step S326.

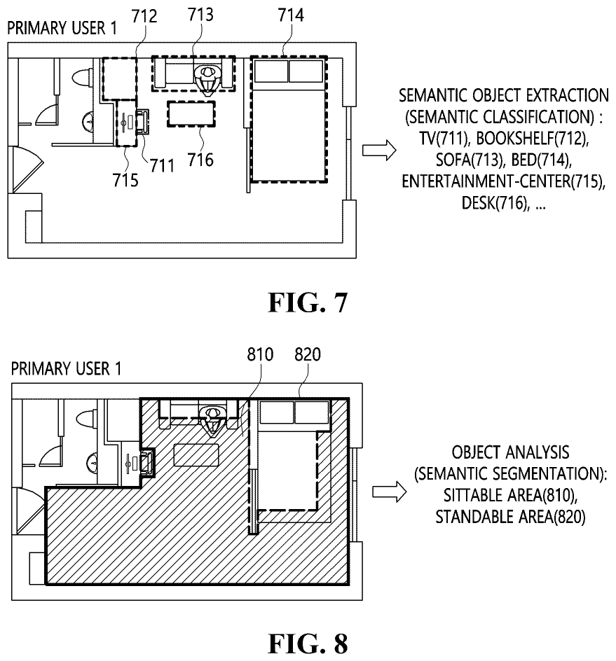

For example, a 3D-type user space may be reconstructed in real time based on images received from the user and the scene prior knowledge, as illustrated in FIG. 6. A semantic object extraction (i.e., semantic classification) process of extracting respective objects 711 to 716, such as a bed, a sofa, a desk, and bookshelf, from the user space reconstructed in this way, may be performed, as illustrated in FIG. 7. Thereafter, as illustrated in FIG. 8, an activity-allowed space 810 may be extracted through an object analysis process of analyzing the relationship of the extracted objects in the user space.

In this case, prior knowledge (recognition, relationship, etc.) about various scenes pre-trained at step S310 may be acquired and analyzed in real time, and a mutually shareable user space may be calculated from spaces understood through such acquisition and analysis at step S328.

For example, individual user spaces may be searched for, and a user space may be calculated using a method of obtaining the maximum value in a 2D coordinate space for areas in which the spaces can intersect.

In detail, the total space that can be used by N users together may be calculated as follows.

First, a space in which interaction with other users is possible may be extracted from spaces in which respective users are capable of individually moving, and rigid-body motion within a two-dimensional (2D) coordinate system for the extracted space may be computed. After, for each user, spaces in which interaction with all other users is possible may be extracted, the total space that can be used together by the N users may be calculated using a method of obtaining values so that an overlapping area, that is, an intersecting area, among the extracted spaces, is maximized.

Thereafter, at mutual space optimization step S330, a virtual space in which the user space acquired from each of the users is to be reflected at image understanding step S320 may be generated.

Here, the coordinates of the virtual space may be generated, and a process of aligning the virtual space may be performed so that mapping to the user space in the real world is possible. For example, a virtual space model to be shared in the metaverse may be created by tuning or mapping various pre-built graphic virtual 3D models to the mutually shareable space calculated in real time at step S332.

Thereafter, an activity-allowed space in which the actual user is capable of moving within the user space calculated at step S328 may be extracted. The reason for this is that various objects such as a chair (sofa) or a table are present in the user space, and thus a space in which movement is impossible is also present in spite of the presence of a space area. Therefore, in order to provide a service that is capable of not only visually sharing the virtual space world within the metaverse space but also physically utilizing the virtual space world, an operation of extracting the activity-allowed space and simplifying the extracted activity-allowed space to be suitable for space mapping may be performed as in the case of step S334.

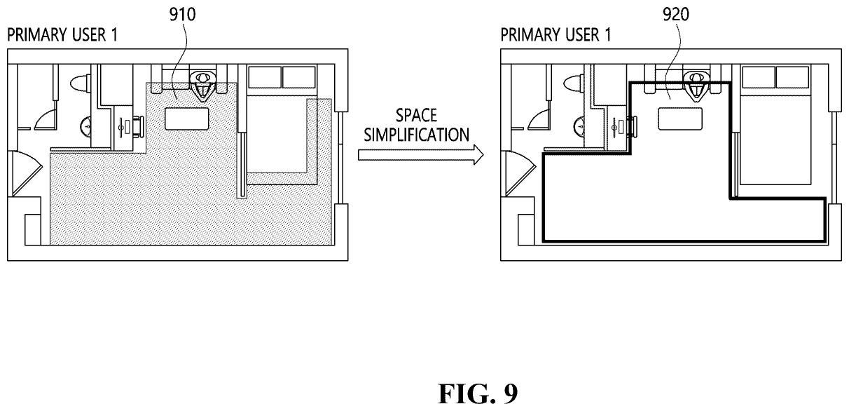

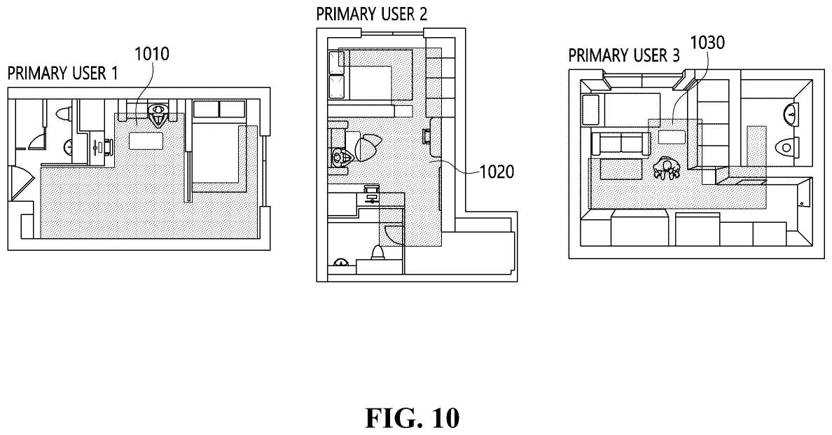

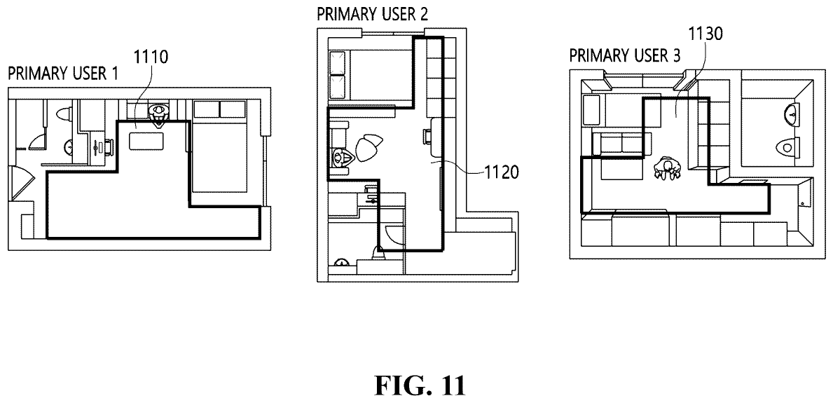

For example, as illustrated in FIGS. 7 and 8, in consideration of information about analyzed objects, an activity-allowed space 810 may be extracted. As illustrated in FIG. 9, a simplified activity-allowed space 920 may be acquired through an operation of simplifying an activity-allowed space 910. This process may be applied to individual user spaces, as illustrated in FIGS. 10 and 11.

In this case, since the activity-allowed space is the space that will be shared later with other users, physical collision processing or the like may also be included in the corresponding operation as needed.

Thereafter, real objects present in the physical space of each user may be mapped to virtual objects located in the virtual space in the metaverse, generated at step S332, at step S336.

In this case, the users may select a virtual model before the real objects are mapped to the metaverse space. For example, a virtual object model to which a real object is to be mapped may be selected based on a module that fits the virtual model to be identical or similar to the real object's use and functionality.

Thereafter, a mutually shareable meta-space may be generated by fitting the physical space of each user to the virtual space built in the metaverse at step S338.

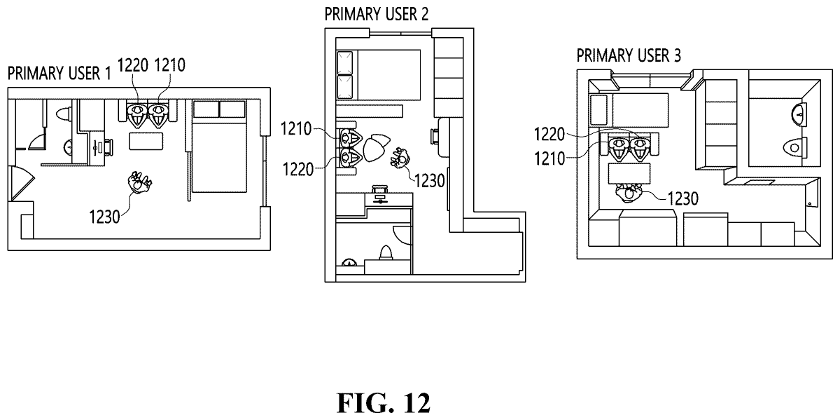

For example, meta-spaces that can be shared by individual primary users 1210 to 1230 in the aligned space, as illustrated in FIG. 12, may be generated and shared by aligning the mutually shareable spaces that are found through the process such as that illustrated in FIGS. 9 to 11.

In this case, referring to FIGS. 10 and 11, spaces found as mutually shareable spaces have similar activity-allowed spaces 1010 to 1030, and thus the sizes or shapes of activity-allowed spaces 1110 to 1130 simplified through the space simplification operation may match each other.

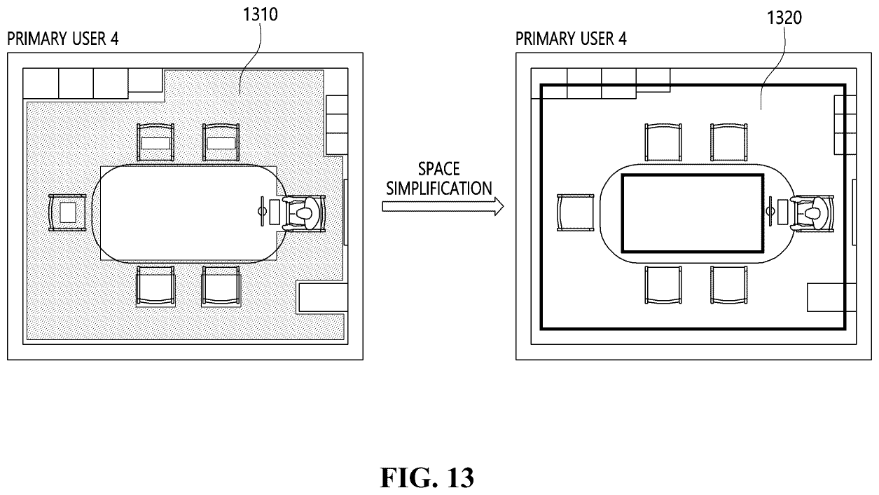

In another example, referring to FIGS. 13 to 15, a process of generating a meta-space based on the user space of primary user 1 and the user space of primary user 4 may be explained.

First, in the case of the user space of primary user 4 illustrated in FIG. 13, a simplified activity-allowed space 1320 may be extracted by simplifying an activity-allowed space 1310.

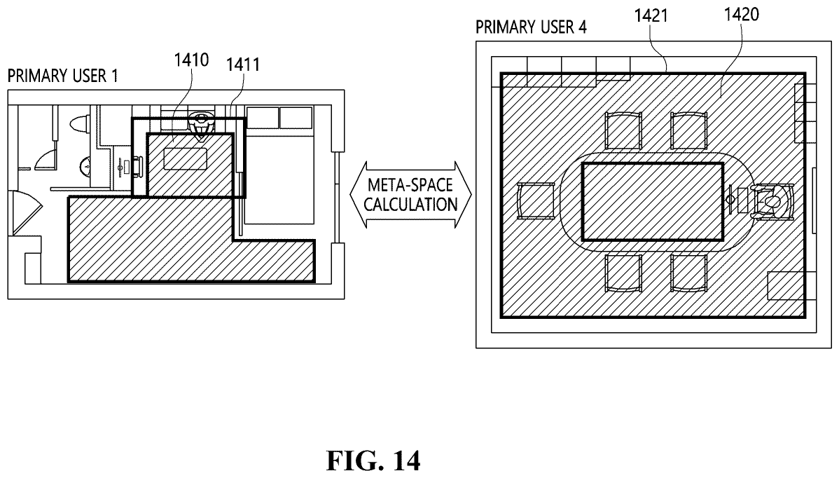

Thereafter, as illustrated in FIG. 14, meta-spaces 1411 and 1421 to be shared in respective user spaces may be generated by comparing a simplified activity-allowed space 1410 of primary user 1 with a simplified activity-allowed space 1420 of primary user 4.

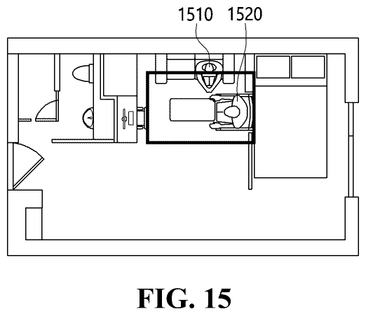

That is, when the meta-space is generated from the user space of primary user 1, the meta-space 1411 to be shared may be calculated by computing positions at which the table and chair of primary user 4 1520 are to be deployed with respect to the surroundings of the sofa and table of primary user 1 1510, as illustrated in FIG. 15. That is, the meta-space 1411 to be shared by primary user 1 1510 may be used together with primary user 4 1520, and the meta-space 1421 to be shared by primary user 4 1520 may be used together with primary user 1 1510.

Here, the meta-spaces according to the present disclosure refer to platforms which extend from normal virtual spaces and in which various activities of users are possible, and may also be generated through a module for performing step S332 depending on the service construction design.

Further, in the present disclosure, each user may edit not only his or her own user space but also the user spaces of other users when sharing and interacting with the user space calculated at step S328 as a meta-space in the metaverse.

In this case, editing tools may be selected based on convenient devices (e.g., wearable devices, hand-held devices, etc.) for respective users.

Also, modified results obtained by editing the spaces to be shared together may be shared through various devices of the corresponding user. For example, a user who owns a haptic device may share the space edited by another user or the user himself or herself not only visually but also through the tactile sensation.

Here, objects present in the mutually shareable meta-space may be edited, and the corresponding objects may correspond to models of real objects obtained through processing at steps S300 to S320. For example, assuming that user A modifies a chair placed in a meta-space into another form, the chair edited by user A may be shared with other users who share the meta-space, and the modified result of the chair may also be shared in various forms depending on the input/output device of the corresponding user at step S340.

That is, because each of multiple users, who share the shared space, maps the user's own space to the virtual space by desirably reflecting the physical space characteristics of the user and other users, the mapped virtual space may be edited by the multiple users, and edited information may be shared.

Furthermore, in the present disclosure, input/output devices used by users may be unified depending on service utilization fields. For example, in the case of a service requiring a collaborative operation, or a service to which users simultaneously need to react to and provide feedback to the same sensation, input/output devices used by users may be unified.

Here, as described above with reference to the foregoing module, all of the position/orientation/scale of the results shared/edited by output devices used by users may be aligned to the space, referred to as a meta-space, to which the physical space of each user is mapped, and the modified results may also be aligned to real objects, and may then be synthesized/displayed at step S350.

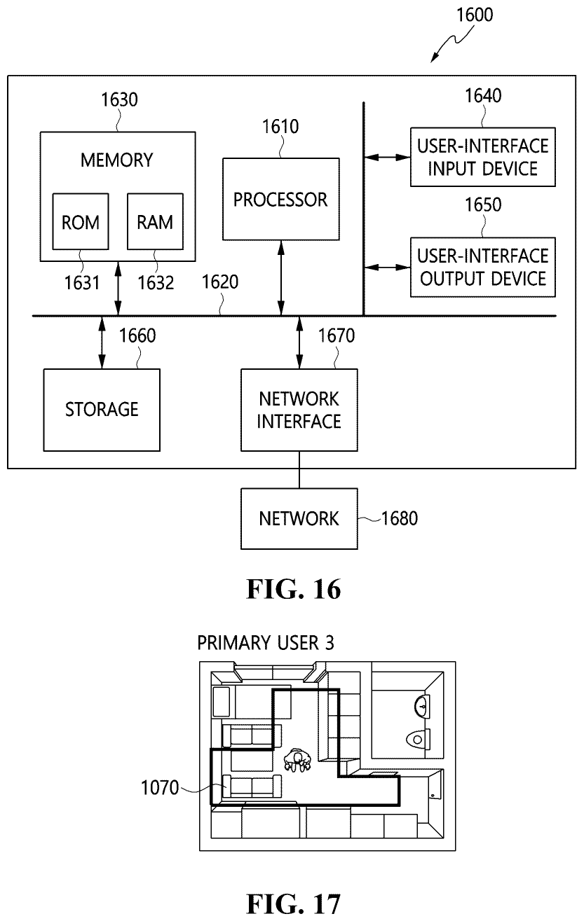

FIG. 16 is a block diagram illustrating a meta-space generation apparatus according to an embodiment of the present disclosure.

Referring to FIG. 16, a meta-space generation apparatus according to an embodiment of the present disclosure may be implemented in a computer system such as a computer-readable storage medium. As illustrated in FIG. 16, a computer system 1600 may include one or more processors 1610, memory 1630, a user interface input device 1640, a user interface output device 1650, and storage 1660, which communicate with each other through a bus 1620. The computer system 1600 may further include a network interface 1670 connected to a network 1680. Each processor 1610 may be a Central Processing Unit (CPU) or a semiconductor device for executing programs or processing instructions stored in the memory 1630 or the storage 1660. Each of the memory 1630 and the storage 1660 may be any of various types of volatile or nonvolatile storage media. For example, the memory 1630 may include Read-Only Memory (ROM) 1631 or Random Access Memory (RAM) 1632.

Therefore, the embodiment of the present disclosure may be implemented as a non-transitory computer-readable medium in which a computer-implemented method or computer-executable instructions are stored. When the computer-readable instructions are executed by the processor, the computer-readable instructions may perform the method according to at least one aspect of the present disclosure.

The processor 1610 generates a user space having a 3D virtual space form based on a user space image captured by a user terminal.

Here, pieces of object information about real objects included in the user space image may be obtained based on a big data-based object database (DB), and the objects may be mapped to the user space in accordance with the pieces of object information.

Also, the processor 1610 analyzes the structural features of the user space in consideration of background and objects constituting the user space.

In addition, the processor 1610 searches for a mutually shareable space that satisfies alignment conditions in which the structural features are taken into consideration, based on user space data of other users registered in a user space database.

Here, the alignment conditions may include a condition ensuring that the similarity to the background of the user space is equal to or higher than a reference level and a condition ensuring that an activity-allowed space, extracted in consideration of the structural features, does not overlap between the user space and the mutually shareable space.

Here, the mutually shareable space may be the user space of another user, generated through the other user's terminal.

Furthermore, the processor 1610 generates a meta-space shareable with other users in the metaverse by aligning the user space to the mutually shareable space.

Here, the meta-space may be generated to include all of objects constituting the user space and objects constituting the mutually shareable space.

Here, alignment may be performed on the position, orientation, and scale between the user space and the mutually shareable space.

Here, the meta-space may be edited by multiple users who share the meta-space.

In this case, when there are two or more mutually shareable spaces, the meta-space may be generated by aligning the two or more mutually shareable spaces to the user space within a range in which the alignment conditions are satisfied.

Here, although not illustrated in FIG. 16, the meta-space generation apparatus according to the embodiment of the present disclosure may include the user space database which stores user space data.

By utilizing the meta-space generation apparatus, there can be provided technology configured such that, when various types of information acquired in real-time by various multiple users are fused, the users may be provided with information suitable for environments and conditions of the users and may further generate a meta-space in which free interaction and editing are possible.

In addition, objects in the meta-space that can be shared while enabling interactions may be configured based on big data obtained from the multiple users.

In addition, there can be provided technology that allows real objects in a physical space to be edited and modified in accordance with individual users' needs through a mutually shared meta-space, without requiring physical space movement.

FIGS. 17 to 19 are diagrams illustrating an example of a meta-space update process based on editing according to the present disclosure.

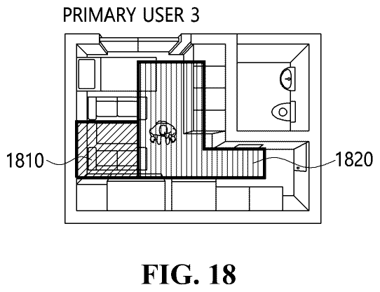

First, FIG. 17 shows that a new object 1710 is added by editing based on the activity-allowed space of primary user 3 illustrated in FIG. 11. That is, assuming that primary user 3 additionally deploys the new object 1710 in his or her user space using an editing tool according to an embodiment of the present disclosure, the activity-allowed space of primary user 3 may be changed, as illustrated in FIG. 18.

Referring to FIG. 18, it can be seen that a non-activity space 1810 is added through editing by primary user 3, and thus a change has occurred in an activity-allowed space 1820. In this case, such a change may influence other users who share the meta-space with primary user 3.

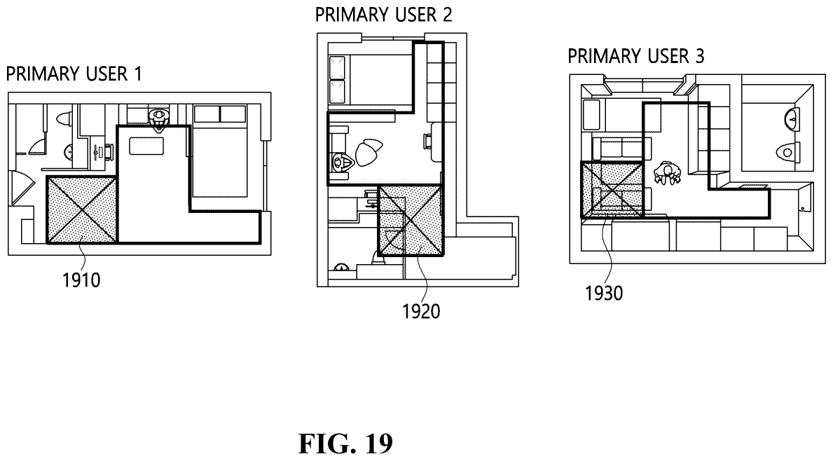

For example, before editing, primary users 1, 2, and 3 who shared the meta-spaces, in the form such as that illustrated in FIG. 11, may share the meta-spaces updated in the form such as that illustrated in FIG. 19, due to editing by primary user 3, as illustrated in FIG. 17.

In detail, primary user 1 cannot move to a space 1910 in which activities are impossible within the meta-space, and primary user 2 cannot move from the meta-space to a space 1920 in which activities are impossible within the meta-space. Similarly, primary user 3 cannot move to a space 1930 in which activities are impossible by personally deploying the new object in the meta-space.

In this way, when changes occur in the activity-allowed space due to editing by each user who uses the meta-space, such changes are reflected in the meta-space in real time, thus also influencing activities in the meta-spaces of users who share the meta-space.

In accordance with the present disclosure, there can be provided technology configured such that, when various types of information acquired in real-time by various multiple users are fused, the users may be provided with information suitable for environments and conditions of the users and may further generate a meta-space in which free interaction and editing are possible.

Further, the present disclosure may configure objects in the meta-space, which can be shared by multiple users while performing interactions, based on big data acquired from the multiple users.

Furthermore, the present disclosure may provide technology that allows real objects in a physical space to be edited and modified in accordance with individual users' needs through a mutually shared meta-space, without requiring physical space movement.

As described above, in the meta-space generation method based on user space alignment in metaverse and the apparatus for the method according to the present disclosure, the configurations and schemes in the above-described embodiments are not limitedly applied, and some or all of the above embodiments can be selectively combined and configured so that various modifications are possible.

What is claimed is:

1. A meta-space generation method performed by a meta-space generation apparatus, the meta-space generation method comprising:
generating a user space having a three-dimensional (3D) virtual space form based on a user space image captured through a user terminal;
analyzing a structural feature of the user space in consideration of a background and objects that constitute the user space;
searching for a mutually shareable space that satisfies alignment conditions in which the structural feature is taken into consideration based on user space data of other users registered in a user space database; and
generating a meta-space that is mutually shareable with other users in metaverse by aligning the user space to the mutually shareable space.

2. The meta-space generation method of claim 1, wherein the alignment conditions comprise a condition ensuring that similarity to the background of the user space is equal to or higher than a reference level and a condition ensuring that an activity-allowed space, extracted in consideration of the structural feature, does not overlap between the user space and the mutually shareable space.

3. The meta-space generation method of claim 1, wherein the meta-space is generated to include all of objects constituting the user space and objects constituting the mutually shareable space.

4. The meta-space generation method of claim 1, wherein generating the meta-space comprises:
performing alignment on a position, orientation, and a scale between the user space and the mutually shareable space.

5. The meta-space generation method of claim 1, wherein the mutually shareable space is a user space for each of the other users generated through user terminals thereof.

6. The meta-space generation method of claim 3, wherein the meta-space is capable of being edited by multiple users who share the meta-space, and edited information is shared with the multiple users who share the meta-space.

7. The meta-space generation method of claim 2, wherein, when a change occurs in an activity-allowed space in the user space or in an activity-allowed space in the mutually shareable space due to editing, the meta-space is updated to correspond to a changed activity-allowed space.

8. The meta-space generation method of claim 1, wherein generating the user space comprises:
obtaining object information about real objects included in the user space image based on a big data-based object database, and mapping the objects to the user space in accordance with the object information.

9. The meta-space generation method of claim 1, wherein generating the meta-space comprises:
when two or more mutually shareable spaces are present, generating the meta-space by aligning the two or more mutually shareable spaces to the user space within a range in which the alignment conditions are satisfied.

10. A meta-space generation apparatus, comprising:
a processor configured to generate a user space having a three-dimensional (3D) virtual space form based on a user space image captured through a user terminal, analyze a structural feature of the user space in consideration of a background and objects that constitute the user space, search for a mutually shareable space that satisfies alignment conditions in which the structural feature is taken into consideration based on user space data of other users registered in a user space database, and generate a meta-space that is mutually shareable with other users in metaverse by aligning the user space to the mutually shareable space; and
a user space database configured to store the user space data.

11. The meta-space generation method of claim 10, wherein the alignment conditions comprise a condition ensuring that similarity to the background of the user space is equal to or higher than a reference level and a condition ensuring that an activity-allowed space, extracted in consideration of the structural feature, does not overlap between the user space and the mutually shareable space.

12. The meta-space generation method of claim 10, wherein the meta-space is generated to include all of objects constituting the user space and objects constituting the mutually shareable space.

13. The meta-space generation method of claim 10, wherein the processor is configured to perform alignment on a position, orientation, and a scale between the user space and the mutually shareable space.

14. The meta-space generation method of claim 10, wherein the mutually shareable space is a user space for each of the other users generated through user terminals thereof.

15. The meta-space generation method of claim 11, wherein the meta-space is capable of being edited by multiple users who share the meta-space, and edited information is shared with the multiple users who share the meta-space.

16. The meta-space generation method of claim 15, wherein, when a change occurs in an activity-allowed space in the user space or in an activity-allowed space in the mutually shareable space due to editing, the meta-space is updated to correspond to a changed activity-allowed space.

17. The meta-space generation method of claim 10, wherein the processor is configured to obtain object information about real objects included in the user space image based on a big data-based object database, and map the objects to the user space in accordance with the object information.

18. The meta-space generation method of claim 10, wherein the processor is configured to, when two or more mutually shareable spaces are present, generate the meta-space by aligning the two or more mutually shareable spaces to the user space within a range in which the alignment conditions are satisfied.
